(19) United States
(12) Patent Application Publication
(10) Pub. No.: US 2004/0194445 A1
(43) Pub. Date: Oct. 7, 2004

(54) Antimatter engine

(76) Inventor: Fernando De La Pena LIaca, Tulancingo (MX)

Correspondence Address: Fernando De La Pena LIaca, 4015 N. Water Iris Ct, Houston, TX, 77059, US

(21) Appl. No.: 10/406,107

(22) Filed: Apr. 4, 2003

(51) Int. Cl. F02K 1/00

(52) U.S. Cl. 60/200.1

(57) ABSTRACT

The invention relates to the use of the collision of matter and antimatter as a means of propulsion in a spacecraft, to the control system for said engine and to a block diagram of the connections for same, in which all of the functions are divided into modules. Said invention refers to a form of propulsion that is totally different to those know at present, which enables spacecraft to move considerably faster in outer space and to reach up to one third of the speed light owing to the controlled collision of matter and antimatter. The control system works in conjunction with the engine in order to control the collision and to maintain the optimal parameters for performing said movement.

Antimatter Engine, prior application PCT/MX01/00029 filled on May 31, 2001, published on Oct. 31, 2002, inventor name: Fernando De La Peña Llaca.

This invention pertains to the field of spacecrafts engines, this engine improves considerably the speed of a spacecraft, using clean elements like hydrogen or anti-hydrogen.

### DESCRIPTION OF THE INVENTION

The detailed characteristics of the engine are shown clearly in the following description and in the accompanying three figures which indicate: the parts, the control system, and the description of the reaction.

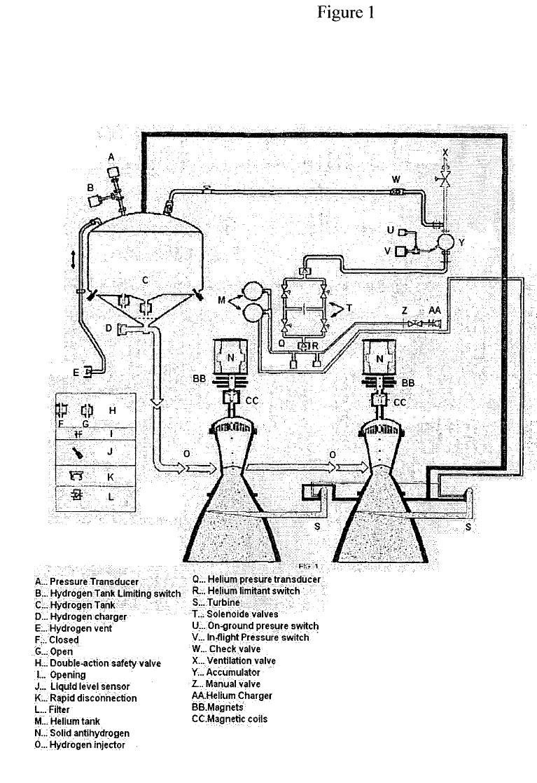

As seen in FIG. 1, the engine is mainly composed of: a hydrogen tank, pressure transducer for the hydrogen tank, a hydrogen tank level switch which indicates the level of hydrogen, a hydrogen charger, two helium tanks, a pressure transducer for the helium tanks, a level switch for each helium tank, a helium charger to fill the tanks, two antimatter containers, magnets, magnetic coils, an accumulator and two turbines.

To start the engine, it is important to analyze the quantity of hydrogen available to create the reaction, which is why there are two sensors that measure the level of liquid, in this case hydrogen, to send to the control system the quantity of hydrogen which will mix with anti-hydrogen (approximately one atom for every anti-atom) to create the required reaction.

Two auxiliary valves that will be releasing hydrogen to the engine, a check valve which will indicate the pressure in the system to see if it is out its limits, in case the control system fails.

The anti-atom continues moving down, but now through magnetic coils, which are placed after the magnets to direct the anti-atom to its destination, without colliding with an atom (the magnets or magnetic coils attract particles to the walls leaving antiparticles free in the center so they will not collide before time).

As anti-atoms move down, the required hydrogen atoms for an explosion begin to be released through hydrogen injectors. The injectors are responsible for sending hydrogen to where the anti-hydrogen is to produce a collision between them and thus causing the required reaction.

As they reach the turbines there is an explosion between atoms and anti-atoms, the turbines function is to change the free energy into kinetic energy, creating propulsion as the turbines spin and direct the explosion, releasing it at the nozzle and thus discharging it in space after creating the required impulse to move the aircraft.

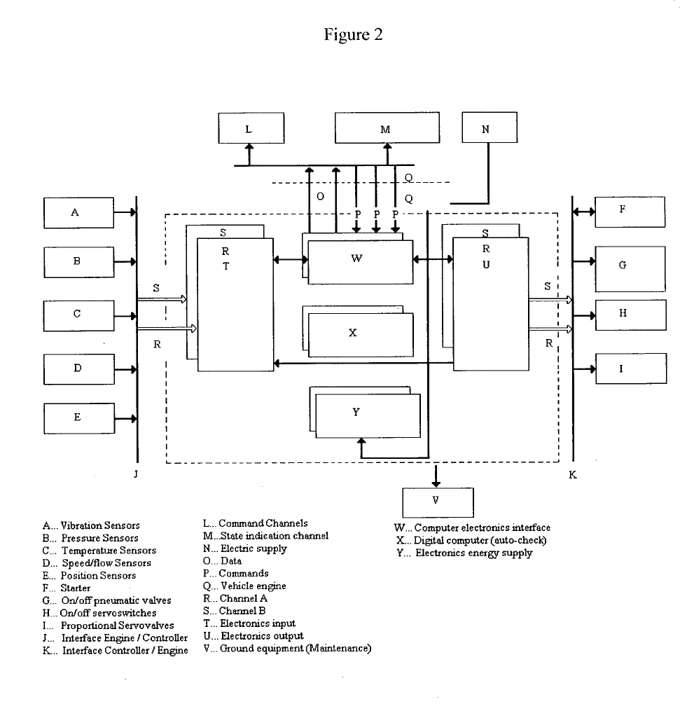

The control system in FIG. 2 is composed of entering data from the engine sensor (entering electronics) divided by vibration, pressure, temperature, fluid/velocity, and position sensors, as well as the electronics input, which is the interface between the engine and the controller channeling the signals given by the entry sensors through two channels (A and B) transforming the signals so the digital computer can read them.

As well as an area for data processing (digital computer) provided by the computer's electronics interface, the computer's function is to be the communicator between the electronics input, to analyze data and to be the bridge at the electronics output. The values are transformed by the computer according to the security ranks to be able to carry out the necessary adjustments at the electronics output and this is done by sending the data to the command channels where security ranks are analyzed and the signal is returned through commands, which the computer interprets to modify the electronics output.

The computer is also connected to state indicator channels which will send signals of the engine's state (levels of temperature, pressure, etc . . . ) and it is connected to an electric power, which will energize the functions of the engine, and you can count on the digital computer's auto check. This part is responsible for ensuring that the computer is running and this is done by a series of operations that verify correct arithmetic operations and the transfer of data. And a maintenance control (ground equipment) is included to provide reports on the computer's operations and to know if there exists an error in the computer's code.

The last section in the control system is the control valves in the engine (electronics output) constituted by the electronics output, which will be the signal sent to the devices, this signal is the one sent by the digital computer, according to the ranks analysis that was performed to make the necessary modifications. The aforementioned is the engine/controller interface for the following devices seen in the figures.

The devices are the starter, open/closed pneumatic valves, open/closed servo switches and proportional servo valves.

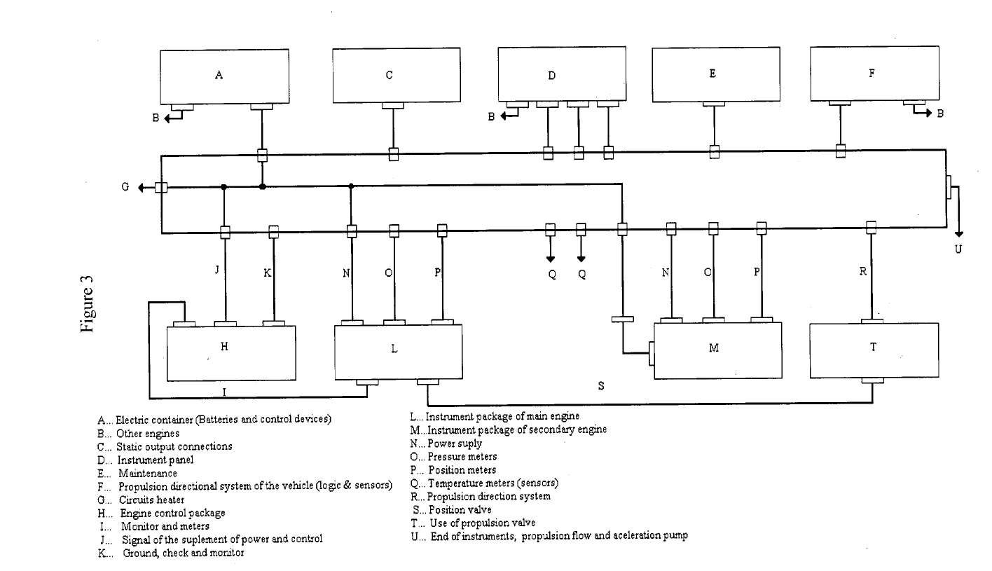

Lastly, in FIG. 3 there is a block diagram, which illustrates the engine's connections.

What I claim as my invention is:

1. The distribution of the engine's components, according to FIG. 1.

2. The type of collision between hydrogen and anti-hydrogen occurs from the combustion chamber to the nozzle.

3. The design uses turbines to direct the impulse of the collision beyond the nozzle.

4. The use of magnetic coils to direct anti-hydrogen.
